(19) United States
(12) Patent Application Publication
(10) Pub. No.: US 2026/0312896 A1
(43) Pub. Date: Oct. 8, 2026

(54) APPLICABILITY REPORTING AND INFERENCE CONFIGURATIONS FOR INFERENCE PROCEDURES

(71) Applicant: QUALCOMM Incorporated, San Diego, CA (US)

(72) Inventors: Rajeev KUMAR, San Diego, CA (US); Hamed PEZESHKI, San Diego, CA (US); Aziz GHOLMIEH, Del Mar, CA (US)

(21) Appl. No.: 19/632,011

(22) Filed: Mar. 27, 2026

Related U.S. Application Data
(60) Provisional application No. 63/783,725, filed on Apr. 4, 2025.

(51) Int. Cl. H04L 43/065; H04B 7/06; H04L 5/00

(52) U.S. Cl. CPC H04L 43/065; H04B 7/0626; H04L 5/0053

(57) ABSTRACT

This disclosure provides methods, components, devices and systems for wireless communications. A user equipment (UE) may receive first control signaling including a set of configuration identifiers corresponding to a set of configurations for inclusion in an applicability report and including one or more indicators indicating whether respective configurations of the set of configurations are for an applicability report. The UE may transmit the applicability report for one or more configurations in accordance with the one or more indicators and based on whether the one or more configurations are applicable for the inference procedures. The UE may receive second control signaling indicating at least one configuration to be used for the inference procedures, where the one or more indicators previously indicated the at least one configuration for the applicability report.

### CROSS REFERENCE

This Patent Application claims the benefit of U.S. Provisional Patent Application No. 63/783,725 by KUMAR et al., entitled “APPLICABILITY REPORTING AND INFERENCE CONFIGURATIONS FOR INFERENCE PROCEDURES,” filed Apr. 4, 2025, assigned to the assignee hereof, and expressly incorporated herein.

### TECHNICAL FIELD

The present disclosure relates generally to wireless communication, and more specifically to systems, devices, methods, and techniques associated with applicability reporting and inference configurations for inference procedures.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a user equipment (UE) is described. The method may include receiving first control signaling including a set of configuration identifiers (IDs) corresponding to a set of configurations (e.g., configurations including inference-related parameter sets, inference configurations, channel state information (CSI) report configurations), the first control signaling further including one or more indicators that indicate whether one or more respective inference configurations from the set of configurations are for an applicability report, transmitting the applicability report for one or more configurations of the set of configurations in accordance with the one or more indicators and based on whether the one or more configurations are applicable for one or more inference procedures, whether the one or more configurations are for inclusion in the applicability report, or both, and receiving, based on the applicability report, second control signaling indicating at least one configuration to be used for the one or more inference procedures, where the at least one configuration is from a subset of configurations for the applicability report.

Another UE for wireless communication is described. The UE may include a processing system that includes processor circuitry and memory circuitry that stores code. The processing system may be configured to cause the UE to receive first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, transmit the applicability report for one or more configurations of the set of configurations in accordance with the one or more indicators and based on whether the one or more configurations are applicable for one or more inference procedures, whether the one or more configurations are for inclusion in the applicability report, or both, and receive, based on the applicability report, second control signaling indicating at least one configuration to be used for the one or more inference procedures, where the at least one configuration is from a subset of configurations for the applicability report.

A UE for wireless communication is described. The UE may include one or more memories storing processor-executable code and one or more processors coupled with the one or more memories. The one or more processors may be individually or collectively operable to execute the code to cause the UE to receive first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, transmit the applicability report for one or more configurations of the set of configurations in accordance with the one or more indicators and based on whether the one or more configurations are applicable for one or more inference procedures, whether the one or more configurations are for inclusion in the applicability report, or both, and receive, based on the applicability report, second control signaling indicating at least one configuration to be used for the one or more inference procedures, where the at least one configuration is from a subset of configurations for the applicability report.

Another UE for wireless communication is described. The UE may include means for receiving first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, means for transmitting the applicability report for one or more configurations of the set of configurations in accordance with the one or more indicators and based on whether the one or more configurations are applicable for one or more inference procedures, whether the one or more configurations are for inclusion in the applicability report, or both, and means for receiving, based on the applicability report, second control signaling indicating at least one configuration to be used for the one or more inference procedures, where the at least one configuration is from a subset of configurations for the applicability report.

A non-transitory computer-readable medium storing code for wireless communication is described. The code may include instructions executable by one or more processors to receive first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, transmit the applicability report for one or more configurations of the set of configurations in accordance with the one or more indicators and based on whether the one or more configurations are applicable for one or more inference procedures, whether the one or more configurations are for inclusion in the applicability report, or both, and receive, based on the applicability report, second control signaling indicating at least one configuration to be used for the one or more inference procedures, where the at least one configuration is from a subset of configurations for the applicability report.

In some examples of the method, UEs, and non-transitory computer-readable medium described herein, the first control signaling may be received via a radio resource control (RRC) reconfiguration message that indicates one or more RRC configurations for applicability reporting, or one or more parameters, or any combination thereof.

In some examples of the method, UEs, and non-transitory computer-readable medium described herein, receiving the second control signaling may include operations, features, means, or instructions for receiving a RRC reconfiguration message indicating one or more inference configurations corresponding to the at least one configuration indicated for the applicability report via the one or more indicators.

Some examples of the method, UEs, and non-transitory computer-readable medium described herein may further include operations, features, means, or instructions for receiving, via the second control signaling, one or more additional indicators including at least one indicator that may be different from an indicator of the one or more indicators received via the first control signaling, where the at least one indicator indicates the at least one configuration to be used for the one or more inference procedures.

In some examples of the method, UEs, and non-transitory computer-readable medium described herein, the one or more indicators may indicate whether the one or more respective inference configurations from the set of configurations are for the applicability report and excluded from use with the one or more inference procedures until additional control signaling enables the one or more respective inference configurations for use with the one or more inference procedures, where the at least one configuration indicated via the second control signaling may be from a subset of configurations for the applicability report and excluded from use with the one or more inference procedures.

Some examples of the method, UEs, and non-transitory computer-readable medium described herein may further include operations, features, means, or instructions for receiving one or more additional indicators via the second control signaling, the one or more additional indicators including at least one indicator that updates an indicator of the one or more indicators received via the first control signaling, where, the at least one indicator signals that a first configuration may be available for use with the one or more inference procedures, where the first configuration was previously signaled by the one or more indicators as being for the applicability report and excluded from use with the one or more inference procedures, and the at least one indicator signals that a second configuration may be for the applicability report and may be excluded from use with the one or more inference procedures, where the second configuration was previously signaled by the one or more indicators as being available for the one or more inference procedures.

In some examples of the method, UEs, and non-transitory computer-readable medium described herein, the one or more indicators include one or more respective flags that each correspond to a configuration of the set of configurations and a value of the one or more respective flags indicates whether the configuration may be for the applicability report.

In some examples of the method, UEs, and non-transitory computer-readable medium described herein, the one or more indicators include a bitmap indicating whether the one or more respective inference configurations may be for the applicability report and excluded from use with the one or more inference procedures or whether the one or more respective inference configurations may be for the applicability report and available for use with the one or more inference procedures, or any combination thereof.

A method for wireless communication by a network node is described. The method may include outputting first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, obtaining the applicability report for one or more configurations of the set of configurations in accordance with the one or more indicators and based on whether the one or more configurations are applicable for one or more inference procedures, whether the one or more configurations are for inclusion in the applicability report, or both, and outputting, based on the applicability report, second control signaling indicating at least one configuration to be used for the one or more inference procedures, where the at least one configuration is from a subset of configurations for the applicability report.

A network node for wireless communication is described. The network node may include a processing system that includes processor circuitry and memory circuitry that stores code. The processing system may be configured to cause the network node to output first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, obtain the applicability report for one or more configurations of the set of configurations in accordance with the one or more indicators and based on whether the one or more configurations are applicable for one or more inference procedures, whether the one or more configurations are for inclusion in the applicability report, or both, and output, based on the applicability report, second control signaling indicating at least one configuration to be used for the one or more inference procedures, where the at least one configuration is from a subset of configurations for the applicability report.

Another network node for wireless communication is described. The network node may include one or more memories storing processor-executable code and one or more processors coupled with the one or more memories. The one or more processors may be individually or collectively operable to execute the code to cause the network node to output first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, obtain the applicability report for one or more configurations of the set of configurations in accordance with the one or more indicators and based on whether the one or more configurations are applicable for one or more inference procedures, whether the one or more configurations are for inclusion in the applicability report, or both, and output, based on the applicability report, second control signaling indicating at least one configuration to be used for the one or more inference procedures, where the at least one configuration is from a subset of configurations for the applicability report.

Another network node for wireless communication is described. The network node may include means for outputting first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, means for obtaining the applicability report for one or more configurations of the set of configurations in accordance with the one or more indicators and based on whether the one or more configurations are applicable for one or more inference procedures, whether the one or more configurations are for inclusion in the applicability report, or both, and means for outputting, based on the applicability report, second control signaling indicating at least one configuration to be used for the one or more inference procedures, where the at least one configuration is from a subset of configurations for the applicability report.

A non-transitory computer-readable medium storing code for wireless communication is described. The code may include instructions executable by one or more processors to output first control signaling including a set of configuration IDs corresponding to a set of configurations (e.g., configurations including inference-related parameter sets, inference configurations, CSI report configurations), the first control signaling further including one or more indicators that indicate whether one or more respective inference configurations from the set of configurations are for an applicability report, obtain the applicability report for one or more configurations of the set of configurations in accordance with the one or more indicators and based on whether the one or more configurations are applicable for one or more inference procedures, whether the one or more configurations are for inclusion in the applicability report, or both, and output, based on the applicability report, second control signaling indicating at least one configuration to be used for the one or more inference procedures, where the at least one configuration is from a subset of configurations for the applicability report.

In some examples of the method, network nodes, and non-transitory computer-readable medium described herein, the first control signaling may be received via a RRC reconfiguration message that indicates one or more RRC configurations for applicability reporting, or one or more parameters, or any combination thereof.

In some examples of the method, network nodes, and non-transitory computer-readable medium described herein, outputting the second control signaling may include operations, features, means, or instructions for outputting a RRC reconfiguration message indicating one or more inference configurations corresponding to the at least one configuration indicated for the applicability report via the one or more indicators.

Some examples of the method, network nodes, and non-transitory computer-readable medium described herein may further include operations, features, means, or instructions for outputting, via the second control signaling, one or more additional indicators including at least one indicator that may be different from an indicator of the one or more indicators received via the first control signaling, where the at least one indicator indicates the at least one configuration to be used for the one or more inference procedures.

In some examples of the method, network nodes, and non-transitory computer-readable medium described herein, the one or more indicators may indicate whether the one or more respective inference configurations from the set of configurations are for the applicability report and excluded from use with the one or more inference procedures until additional control signaling enables the one or more respective inference configurations for use with the one or more inference procedures, where the at least one configuration indicated via the second control signaling may be from a subset of configurations for the applicability report and excluded from use with the one or more inference procedures.

Some examples of the method, network nodes, and non-transitory computer-readable medium described herein may further include operations, features, means, or instructions for outputting one or more additional indicators via the second control signaling, the one or more additional indicators including at least one indicator that updates an indicator of the one or more indicators received via the first control signaling, where, the at least one indicator signals that a first configuration may be available for use with the one or more inference procedures, where the first configuration was previously signaled by the one or more indicators as being for the applicability report and excluded from use with the one or more inference procedures, and the at least one indicator signals that a second configuration may be for the applicability report and may be excluded from use with the one or more inference procedures, where the second configuration was previously signaled by the one or more indicators as being available for the one or more inference procedures.

In some examples of the method, network nodes, and non-transitory computer-readable medium described herein, the one or more indicators include one or more respective flags that each correspond to a configuration of the set of configurations and a value of the one or more respective flags indicates whether the configuration may be for the applicability report.

In some examples of the method, network nodes, and non-transitory computer-readable medium described herein, the one or more indicators include a bitmap indicating whether the one or more respective inference configurations may be for the applicability report and excluded from use with the one or more inference procedures or whether the one or more respective inference configurations may be for the applicability report and available for use with the one or more inference procedures, or any combination thereof.

### BRIEF DESCRIPTION OF THE DRAWINGS

FIG. 1 shows an example of a wireless communication system.

FIG. 2 shows an example of a signaling configuration that supports applicability reporting and inference configurations for inference procedures.

FIG. 3 shows an example of a process flow that supports applicability reporting and inference configurations for inference procedures.

FIG. 4 shows a block diagram of a processing system that supports applicability reporting and inference configurations for inference procedures.

FIG. 5 shows a diagram of a system including a device that supports applicability reporting and inference configurations for inference procedures.

FIG. 6 shows a block diagram of a processing system that supports applicability reporting and inference configurations for inference procedures.

FIG. 7 shows a diagram of a system including a device that supports applicability reporting and inference configurations for inference procedures.

FIGS. 8 through 10 show flowcharts illustrating methods that support applicability reporting and inference configurations for inference procedures.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support AI/ML techniques for beam management, in which a UE may use one or more AI/ML functionalities to perform beam prediction. For example, a UE may perform measurements on a first set of beams (e.g., Set B beams) and use the measurements as an input to predict characteristics of a second set of beams (e.g., Set A beams). A network may request the UE to report supported functionalities, and the UE may send a UE capability information message to the network to report the supported functionalities. The network may configure the UE with one or more inference configurations and/or one or more sets of inference-related parameters based on the supported functionalities. The UE may determine an applicability of the one or more inference configurations, the one or more sets of inference-related parameters, or both, and transmit an applicability report to the network based on the determination. For example, to determine applicability, the network may configure an inference-related parameter set and/or one or more an inference configuration. The inference configuration may be a configuration the UE may use for inference operation, and the configuration may be configured for determining applicability and inference. The inference related parameter set may be associated with a complete configuration as well, but may be restricted by the network to perform inference. In some cases, however, techniques for configuring applicability reporting may be further improved, and a procedure for efficiently indicating which configurations or sets of inference-related parameters, or both, are for inclusion by the UE in applicability reporting (e.g., which configurations and/or sets of parameters are only for inclusion in the applicability reporting and not necessarily for configuring inference procedures) may be beneficial.

Aspects of the subject matter described in this disclosure relate to techniques for indicating configurations for applicability reporting and configuring or enabling inference configurations at UE based on applicability information. A network may configure a UE to perform applicability reporting for one or more configurations (e.g., configurations including one or more inference-related parameter sets, inference configurations, or both). For example, a UE may receive first control signaling including a set of configuration identifiers (IDs) corresponding to a set of one or more configurations (e.g., channel state information (CSI) report configurations, inference configurations, configurations including one or more sets of inference-related parameters, or a combination thereof) that are to be included in an applicability report. The first control signaling may also include one or more indicators that indicate whether each configuration of the set of configurations is for applicability determination only and excluded from use for AI/ML inference. That is, the one or more indicators may signal which configurations of the set of configurations are for applicability reporting only (e.g., only applicability for the configuration is requested). The UE may transmit an applicability report including applicability information (e.g., or inapplicability information) for the set of configurations based on determining whether each configuration of the set of configurations is applicable. The UE may also activate one or more configurations that the UE determines as applicable based on the one or more indicators indicating that the one or more configurations are available for use for AI/ML inference. Based on the applicability report, the network may transmit second control signaling to the UE indicating that at least one configuration that the one or more indicators previously indicated as excluded from use for AI/ML inference is now to be used for AI/ML inference.

Particular aspects of the subject matter described in this disclosure can be implemented to realize one or more of the following potential advantages. In some examples, by facilitating applicability reporting and enablement of AI/ML functionalities, the described techniques can be used to reduce downlink reference signal overhead and UE power consumption. For example, a UE may replace a quantity of measurements with AI/ML inferences and accordingly reduce resource consumption associated with performing the measurements.

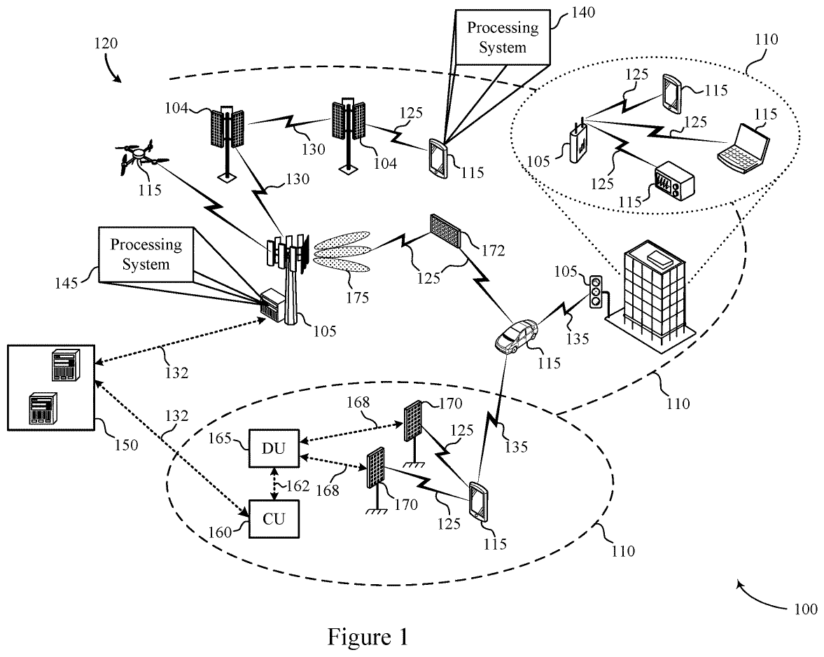

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for applicability reporting and inference configurations for inference procedures. As an example, the wireless communication system 100 may be configured to support aspects of techniques for applicability reporting that includes configurations indicated for applicability reporting only (e.g., including inference related parameter sets). For example, a UE 115 may include a processing system 140, and a network entity 105 may include a processing system 145, each of which may be configured to cause the respective device to perform (such as being configured as means for performing) one or more of the described operations. In some examples, the wireless communication system 100 may support AI/ML beam prediction, and a UE 115 may support a quantity of AI/ML functionalities. A network entity 105 may configure the UE with a quantity of configurations (e.g., CSI report configurations, inference configurations, configurations including one or more inference-related parameter sets) associated with AI/ML inference based on the UE support for the quantity of AI/ML functionalities. The UE 115 may receive first control signaling including a set of configuration IDs corresponding to a set of configurations (e.g., CSI report configurations, inference configurations, configurations including one or more sets of inference-related parameters, or a combination thereof) that are to be included in an applicability report. The first control signaling may also include one or more indicators (such as one or more flags and/or a bitmap) that indicate whether each configuration of the set of configurations is for applicability determination and excluded from use for AI/ML inference. The UE 115 may transmit an applicability report including applicability information (e.g., or inapplicability information) for the set of configurations based on determining whether each configuration of the set of configurations is applicable. The UE 115 may also activate one or more configurations that the UE 115 determines as applicable based on the one or more indicators indicating that the one or more configurations are available for use for AI/ML inference. Based on the applicability report, the network entity 105 may transmit second control signaling to the UE 115 indicating that at least one configuration that the one or more indicators previously indicated as excluded from use for AI/ML inference is now to be used for AI/ML inference.

By configuring a processing system 140, a processing system 145, or a combination thereof in accordance with the described techniques, the wireless communication system 100 (such as the RAN 120) may support reduced downlink reference signal overhead and UE power consumption. For example, a UE 115 may replace a quantity of measurements with AI/ML inferences and accordingly reduce resource consumption associated with performing the measurements.

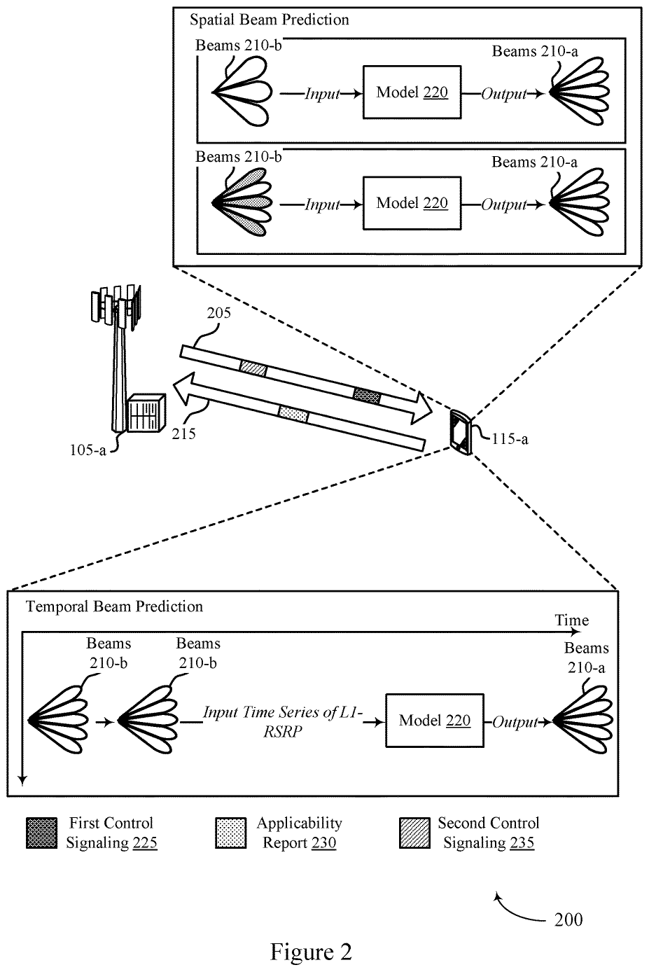

FIG. 2 shows an example of a signaling configuration 200 that supports applicability reporting and inference configurations for inference procedures in accordance with one or more aspects of the present disclosure. In some examples, the signaling configuration 200 may implement, or be implemented by, aspects of the wireless communication system 100. For example, the signaling configuration 200 may include a UE 115-a and a network entity 105-a, which may be examples of corresponding devices as described with reference to FIG. 1.

In some cases, the signaling configuration 200 may support AI/ML techniques for beam management. For instance, the UE 115-a may use one or more AI/ML models 220 (e.g., functionalities) to perform beam prediction. The implementation of AI/ML for beam prediction may reduce downlink reference signal overhead and UE power consumption by using the beam prediction to replace a quantity of measurements.

To illustrate, the UE 115-a may measure respective beams 210 that correspond to one or more reference signals (e.g., synchronization signal blocks (SSBs), CSI-RSs) via a first set of resources, which may be referred to as Set B beams 210-b, during a first set of measurement occasions. Additionally, the UE 115-a may perform beam prediction (e.g., inference, assumption) for a set of beams 210 associated with a second set of resources, which may be referred to as Set A beams 210-a, using an AI/ML model 220, which may be based on historical measurement results of the Set B beams 210-b (e.g., measurements of the Set B beams 210-b may be inputs to the AI/ML model 220). That is, the UE 115-a may use various measurements of the Set B beams 210-b (e.g., L1 reference signal received powers (RSRPs)) to predict one or more characteristics (e.g., measurements) associated with the Set A beams 210-a. In some examples, the UE 115-a may use the one or more AI/ML models 220 based on a training of the one or more AI/ML models 220 (e.g., based on collected or known data) and one or more inference processes by which the one or more AI/ML models 220 may use training to analyze additional data and make one or more predictions. In some cases, the UE 115-a may perform the beam prediction in accordance with a set of parameters, including a Set B beam measurement window length, a Set B beam measurement periodicity, and a prediction duration for Set A beams, among other examples.

In some examples, the one or more AI/ML models 220 may support spatial beam prediction (e.g., beam management case 1). In some cases, the Set B beams 210-b may be wide beams (e.g., corresponding to SSBs), and an AI/ML model 220 may predict a set of narrow Set A beams 210-a (e.g., corresponding to CSI-RSs) using the Set B beams 210-b. In other cases, the Set B beams 210-b and the Set A beams 210-a may both be narrow beams, and the Set B beams 210-b may be a subset of the Set A beams 210-a.

Additionally, or alternatively, the one or more AI/ML models 220 may support temporal beam prediction (e.g., beam management case 2). That is, the UE 115-a may predict measurements associated with Set A beams 210-a that are the same as the measured Set B beams 210-b but are transmitted later in time. For instance, the UE 115-a may input a time series of L1-RSRPs associated with the Set B beams 210-b into an AI/ML model 220 to generate L1-RSRPs associated with the Set A beams 210-a.

In some cases, the UE 115-a and the network entity 105-a may exchange signaling (e.g., via a downlink channel 205 and an uplink channel 215) to report applicable AI/ML configurations, features, feature groups, or functions (e.g., configurations containing one or more inference-related parameter sets, inference configurations, or both). In some aspects, an AI/ML functionality (e.g., that is supported/used by the UE 115-a) may refer to one or more AI/ML feature groups (e.g., which may correspond to one or more capabilities of the UE 115-a), and an applicable AI/ML functionality may refer to an AI/ML configuration that the UE 115-a is ready to apply for inference. The network entity 105-a may transmit, to the UE 115-a, an RRC Reconfiguration message (e.g., RRCReconfiguration) indicating one or more configurations (e.g., one or more CSI report configurations, one or more RRC configurations/parameters) associated with AI/ML enabled features, feature groups, and/or functionalities. In some aspects, the RRC Reconfiguration message may indicate whether a configuration is provided for applicability determination (e.g., in which case the configuration may include one or more inference-related parameter sets) rather than for inference (e.g., in which case the configuration may include an inference configuration). For example, a configuration ID may be associated with a flag (e.g., a 1 bit indicator) that indicates whether the configuration is to be included in an applicability report. However, techniques for configuring the UE 115-a to perform applicability reporting could be further improved, and a procedure for configuring or enabling inference configurations based on the applicability reporting would be beneficial. For instance, the UE 115-a determining applicable AI/ML configurations and the network entity 105-a configuring and/or enabling inference configurations based on the UE 115-a reporting the determined applicable AI/ML configurations may allow for inference to be performed for efficiently (e.g., the network may not need to provide inference configurations in subsequent control messages (e.g., RRC configuration messages), and the existing configurations for applicability reporting only may be used for inference).

Accordingly, the techniques described herein may provide mechanisms for indicating configurations for applicability reporting and a procedure for configuring or enabling inference configurations at UEs based on applicability information (e.g., the UE 115-a). In some examples, the network entity 105-a may transmit first control signaling 225 (e.g., a RRC message, for example RRCReconfiguration including OtherConfig) to the UE 115-a. The first control signaling may indicate (e.g., via one or more indicators) whether applicability reporting for one or more configurations (e.g., inference configurations) is enabled. In some examples, the first control signaling 225 may include a set of configuration IDs corresponding to a set of configurations (e.g., CSI report configurations, RRC configurations such as configurations included in RRCReconfiguration, RRCRelease, or OtherConfig) for which applicability information (e.g., or inapplicability information) is requested. That is, the first control signaling 225 may indicate for the UE 115-a to transmit an applicability report 230 (e.g., RRCReconfigurationComplete, RRCResumeComplete, and/or UE assistance information (UAI)) corresponding to the set of configuration IDs included in the first control signaling 225. The set of configuration IDs may correspond to configurations including inference configurations, configurations including inference-related parameter sets, or a combination thereof.

In some aspects, the first control signaling 225 may include one or more indicators of whether a configuration ID corresponds to a configuration that is provided for applicability determination only and is excluded from use for AI/ML inference (e.g., until additional control signaling enables the configuration for use for AI/ML inference). For instance, the first control signaling 225 may provide an inference configuration corresponding to a configuration ID, but the one or more indicators may indicate for the UE 115-a to refrain from using the inference configuration for AI/ML inference until the UE 115-a receives additional control signaling (e.g., second control signaling 235) containing a reconfiguration or an indication that the UE 115-a may use the inference configuration for AI/ML inference. In some implementations, the one or more indicators may indicate whether a configuration ID corresponds to an inference configuration or to one or more inference-related parameter sets (e.g., OtherConfig).

In some cases, the one or more indicators may be flags (e.g., a one-bit indication, among other examples), where a flag may be set to True (e.g., or 1) if a corresponding configuration is for applicability determination only and excluded from use for AI/ML inference. In some cases, the configuration may be an example of a CSI report configuration. In one example, a configuration may contain one or more inference-related parameter sets, and the configuration may contain a flag indicating that the configuration is for applicability determination only and is excluded from use for AI/ML inference. In another example, a configuration may include an inference configuration, but the flag may indicate that the UE 115-a is to refrain from using the configuration for AI/ML inference and use the configuration for applicability determination only (e.g., the UE 115-a may be prohibited from using the configuration until the configuration is activated (or until the indicator is modified), for example, based on an indicator signaling that the configuration is for applicability reporting only). In some cases, the network entity 105-a may provide one or more tuples, where each tuple includes a configuration ID and a corresponding flag. The flags may be provided in one or more RRC messages (e.g., RRCReconfiguration), or the flags may be integrated within a CSI framework (e.g., included in one or more CSI configuration messages) by implementing an information element (IE) corresponding to the flags (e.g., CSI-ReportConfigApp).

Additionally, or alternatively, the one or more indicators may be a bitmap indicating configurations (e.g., configurations identified in the first control signaling 225) that are for applicability determination only and excluded from use for AI/ML inference. For example, the first control signaling 225 may identify a quantity of configurations (e.g., some of these configurations may include inference configurations while others of these configurations may include one or more inference-related parameter sets), and the network entity 105-a may configure a bitmap of a corresponding length (e.g., if five configurations are identified in the first control signaling 225, the bitmap may include five entries), in which a value of 1 may indicate that a corresponding configuration is for applicability determination only and excluded from use for AI/ML inference and a value of 0 may indicate that the configuration may be used for AI/ML inference (e.g., or vice versa). In some examples, the bitmap may indicate whether a configuration is an inference configuration or a configuration including one or more inference-related parameter sets. In some aspects, the bitmap may be configured via one or more RRC messages (e.g., RRCReconfiguration, RRCRelease), or the bitmap may be integrated within a CSI framework (e.g., included in one or more CSI configuration messages) by implementing an IE corresponding to the flags (e.g., CSI-ReportConfigApp).

The UE 115-a may receive the first control signaling 225 and determine the applicability of the set of configurations identified in the first control signaling 225. For example, the UE 115-a may determine the applicability based on model availability at the UE 115-a, one or more UE-side additional conditions (e.g., internal to the UE 115-a), one or more network-side additional conditions (e.g., which may be indicated via a RRC Reconfiguration message, for example the first control signaling 225), or any combination thereof. The UE 115-a may generate an applicability report 230 including applicability information for the set of configurations and determine whether to use each configuration for inference based on the one or more indicators and determining the applicability.

In cases in which the one or more indicators are flags, the UE 115-a may determine applicability information for the set of configurations identified in the first control signaling 225 and include the applicability information in an applicability report 230. If a configuration (e.g., a kth configuration, such as a kth CSI report configuration, RRC configuration, or a corresponding ID) is applicable and a corresponding flag is set to, for example, True, the UE 115-a may set the applicability of the configuration (e.g., or a corresponding configuration ID) as applicable (e.g., True) and refrain from activating the configuration for inference (e.g., if the configuration is a CSI report configuration, this may be irrespective of reportType, which may indicate the CSI report configuration as periodic, semi-persistent, aperiodic, etc.). If a configuration is applicable and a corresponding flag is set to, for example, False, the UE 115-a may set the applicability of the configuration as applicable and determine to use the configuration for inference. For example, the configuration may be a CSI report configuration, and the UE 115-a may activate (e.g., immediately) the CSI report configuration for inference if a report type (e.g., reportType) of the CSI report configuration is periodic, or the UE 115-a may refrain from activating the CSI report configuration until the network entity 105-a activates the CSI report configuration (e.g., via MAC control element (MAC-CE) or DCI) if the report type of the CSI report configuration is semi-persistent or aperiodic. In some cases, if a configuration is nonapplicable, the UE 115-a may set the applicability of the configuration as nonapplicable (e.g., False). The UE 115-a may include applicability information (e.g., and inapplicability information) for the set of configurations identified in the first control signaling 225 in the applicability report 230 based on setting the applicability of the configurations as applicable or nonapplicable.

In examples in which the one or more indicators are a bitmap, the UE 115-amay determine applicability information (e.g., or inapplicability information) for the set of configurations identified in the first control signaling 225 and include the applicability information in an applicability report 230. If a configuration is applicable, the UE 115-a may set the applicability of the configuration (e.g., or a corresponding configuration ID) as applicable (e.g., or True). If an entry in the bitmap corresponding to the configuration indicates that the configuration is for applicability determination only and excluded from use for AI/ML inference (e.g., if a logical AND operation between the applicability of the configuration and the entry in the bitmap is True or 1), the UE 115-a may refrain from activating the configuration. If the entry indicates that the configuration is not for applicability determination (e.g., if a logical AND operation between the applicability of the configuration and the entry in the bitmap is False or 0), the UE 115-a may use the configuration for inference. If the configuration is a CSI report configuration, the UE 115-a may either activate (e.g., immediately) the CSI report configuration if a corresponding report type is periodic or refrain from activating the CSI report configuration (e.g., until receiving a network indication via MAC-CE or DCI activating the CSI report configuration) if the corresponding report type is semi-persistent or aperiodic. If a configuration is nonapplicable, the UE 115-a may set an applicability of the configuration to nonapplicable (e.g., False). The UE 115-a may include applicability information (e.g., and inapplicability information) for the set of configurations identified in the first control signaling 225 in the applicability report 230 based on setting the applicability of the configurations as applicable or nonapplicable.

The UE 115-a may transmit, to the network entity 105-a, the applicability report 230 including applicability information for the set of configurations identified in the first control signaling 225. The network entity 105-a may determine which configurations to activate and/or inactivate at the UE 115-a based on the one or more indicators (e.g., flags, bitmaps) and the applicability information included in the applicability report 230. The network entity 105-a may transmit second control signaling 235 indicating for inference one or more configurations that the one or more indicators previously indicated as being for applicability determination. For instance, the network entity 105-a may determine that a configuration is applicable at the UE 115-a based on the applicability report 230, and the network entity 105-a may indicate, in the second control signaling 235, for the UE 115-a to use the configuration for inference. Additionally, or alternatively, the network entity 105-a may indicate, via the second control signaling 235, that a configuration that the one or more indicators previously indicated as usable for AI/ML inference is now for applicability determination (e.g., only for an applicability determination) and excluded from use for AI/ML inference (e.g., prohibited from use with one or more inference procedures, until the indicator is updated and/or the configuration is activated).

In some implementations, the second control signaling 235 may be an RRC Reconfiguration message (e.g., RRCReconfiguration) that includes one or more RRC configurations, one or more CSI configurations, one or more inference-related parameter sets, or any combination thereof. For example, the second control signaling 235 may include one or more inference configurations (e.g., CSI-ReportConfig for inference) corresponding to one or more configuration IDs that the applicability report 230 indicates as applicable and that the one or more indicators previously indicated as being excluded from use for AI/ML inference. In some cases, the network entity 105-a may configure the UE 115-a with inference configurations for applicable configuration IDs for which the UE 115-a first control signaling 235 previously configured a configuration including one or more inference-related parameter sets (e.g., instead of an inference configuration). In some examples, the second control signaling 235 may additionally include an indication to release a previous configuration (e.g., including the one or more inference-related parameter sets), stop evaluating the previous configuration, or both for the one or more configuration IDs corresponding to the one or more inference configurations included in the second control signaling 235. In some examples, the second control signaling 235 may include a mapping between the one or more inference configurations and one or more previous configurations for the one or more configuration IDs.

In such implementations, the UE 115-a may receive the second control signaling 235 and use the one or more inference configurations included in the second control signaling 235 for inference procedures. In some cases, a configuration for inference (e.g., included in the second control signaling 235) may be associated with periodic CSI reporting (e.g., reportType is periodic), and the UE 115-a may immediately activate the configuration for inference and begin performing CSI reporting in accordance with the configuration for inference. In some examples, a configuration for inference may be associated with aperiodic or semipersistent CSI report (e.g., reportType is aperiodic or semipersistent), and the UE 115-a may refrain from activating the configuration for inference until receiving a network indication (e.g., a MAC-CE or DCI from the network entity 105-a) to activate the configuration for inference. In some aspects, the UE 115-a may stop evaluating, release, or both one or more configurations indicated as being for applicability determination only and excluded from use for AI/ML inference (e.g., previously indicated by a flag or bitmap in the first control signaling 225) in response to receiving the second control signaling 235. For instance, if the second control signaling includes a configuration for inference corresponding to a configuration ID, the UE 115-a may stop evaluating and/or release a configuration including one or more inference-related parameter sets that corresponds to the configuration ID and that the one or more indicators of the first control signaling 225 previously indicated as being a configuration for applicability determination only and excluded from use for AI/ML inference.

Additionally, or alternatively, the second control signaling 235 may include one or more additional indicators (e.g., flags, bitmaps) indicating for inference one or more configurations that the one or more indicators of the first control signaling 225 previously indicated as being excluded for use for AI/ML inference (e.g., indicated as being only for the applicability reporting). The one or more additional indicators may overwrite one or more indicators of the first control signaling 225, which may allow the UE 115-a to perform inference using inference configurations previously provided in the first control signaling 225 (e.g., without the network entity 105-a transmitting an RRC configuration/reconfiguration to provide inference configurations for one or more applicable configuration IDs). For example, the UE 115-a may report a configuration as applicable in the applicability report 230, and the second control signaling 235 may include an updated flag for the configuration indicating that the configuration is available for use for AI/ML inference (e.g., a value of the updated flag may be False). In another example, the UE 115-a may report a set of configurations as applicable in the applicability report 230, and the second control signaling 235 may include an updated bitmap with updated entries corresponding to the set of configurations that indicate that may indicate one or more configurations of the set of configurations are available for use for AI/ML inference (e.g., values of the updated entries may be 0). The network entity 105-a may transmit the second control signaling 235 via an RRC message (e.g., RRCReconfiguration), a MAC-CE, DCI, or any combination thereof. In some cases, the one or more additional indicators may indicate that one or more configurations that the one or more indicators of the first control signaling 225 previously indicated as being available for use for AI/ML inference are now for applicability determination and excluded from use for AI/ML inference, or vice versa. For instance, an updated flag and/or bitmap entry may update a value associated with the one or more configurations from True to False, or vice versa. That is, one or more indicators (flags, bitmap) may update one or more of the previously provided indicators, where the one or more updated indicators may signal that one or more configurations provided for applicability reporting only (and prohibited from use with a configuration for AI/ML inference until enablement by the second control signaling 235) may be now used for inference. Similarly, one or more updated indicators may signal that one or more configuration previously provided for applicability reporting and inference (where the UE 115-a is allowed to use the configuration for AI/ML inference) may be now used for applicability reporting only (and prohibited from being used for the configuration for AI/ML inference procedures until enabled by additional control signaling).

The UE 115-a may receive the second control signaling 235 including the one or more additional indicators and perform inference and applicability reporting in accordance with the one or more additional indicators. The one or more additional indicators (e.g., flags, bitmaps) may include one or more indicators for one or more configurations that the one or more indicators of the first control signaling 225 previously indicated as being for applicability determination only and excluded from use for AI/ML inference, and the UE 115-a may ignore the one or more indicators of the first control signaling 225 and instead behave in accordance with the one or more additional indicators. If the second control signaling 235 does not provide an indicator for a particular configuration, the UE 115-a may behave in accordance with a corresponding indicator of the first control signaling 225 for that particular configuration.

For example, the one or more additional indicators may include flags for one or more configurations that the UE 115-a indicated as applicable in the applicability report 230, and these flags may be set to False to indicate that the one or more configurations are no longer excluded from use for AI/ML inference. The UE 115-a may then use the one or more configurations for inference (e.g., immediately activate if a report type is periodic or activate after receiving a network indication if a report type if aperiodic or semipersistent) based on the corresponding flags being set to False and the one or more configurations being applicable. Similarly, the one or more additional indicators may be a bitmap with updated entries (e.g., that overwrites a bitmap of the first control signaling 225) corresponding to the one or more configurations that the UE 115-a indicated as applicable in the applicability report 230, and these updated entries may indicate that the one or more configurations are no longer excluded from use for AI/ML inference (e.g., values of the updated entries may be 0). The UE 115-a may then use the one or more configurations for inference based on the one or more configurations being applicable and the corresponding entries in the bitmap indicating that the configurations are for inference.

The examples described herein regarding the information signaled by the one or more indicators (such as True, False, 0, 1, or the like) are provided for illustrative purposes only, and other information may be signaled to indicate whether one or more configurations are for applicability reporting (e.g., for applicability reporting only). That is, other possible indications, values, signaling, or the like, may be possible, and the example indications described herein should not be considered limiting to the scope of the claims or the disclosure.

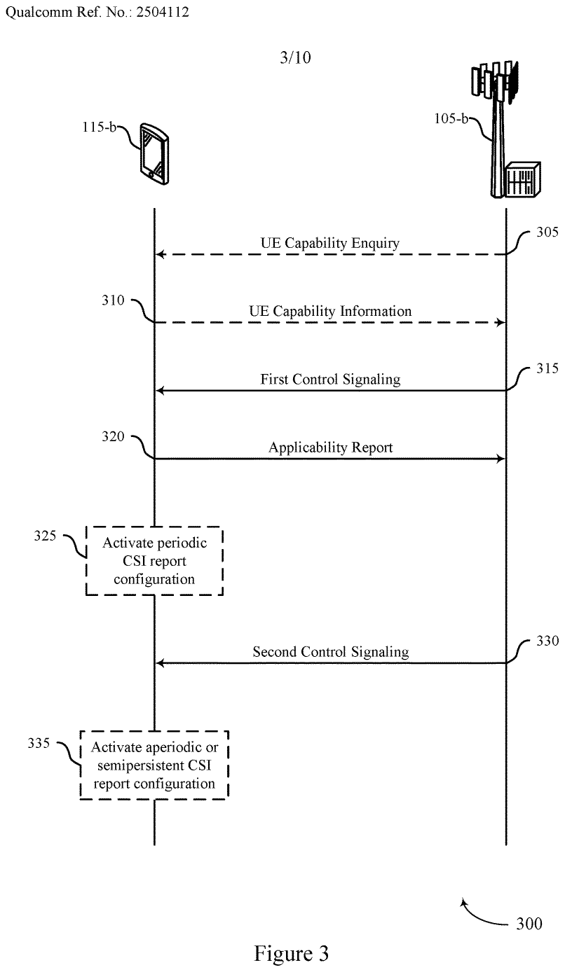

FIG. 3 shows an example of a process flow 300 that supports applicability reporting and inference configurations for inference procedures in accordance with one or more aspects of the present disclosure. In some examples, the process flow 300 may implement or be implemented to realize aspects of the wireless communication system 100 and the signaling configuration 200. For example, the process flow 300 may include a UE 115-b and a network entity 105-b, which may be examples of the UE 115-a and the network entity 105-a, respectively, as illustrated in FIG. 2.

In the following description of the process flow 300, the operations between the UE 115-b and the network entity 105-b may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the network entity 105-b may, in some examples, transmit a UE capability enquiry message (e.g., UECapabilityEnquiry) to the UE 115-b. The UE capability enquiry message may trigger the UE 115-b to report AI/ML enabled features, feature groups, and/or functions that are supported by the UE 115-b.

At 310, the UE 115-b may, in some cases, transmit a UE capability information message (e.g., UECapabilityInformation) to the network entity 105-b in response to the UE capability enquiry message. The UE capability information message may contain an indication of AI/ML enabled features, feature groups, and/or functions that are supported by the UE 115-b. The UE 115-b may transmit the UE capability information message via an RRC message or LTE Positioning Protocol (LPP) signaling.

At 315, the UE 115-b may receive, and the network entity 105-b may output, first control signaling (e.g., a RRC message, for example RRCReconfiguration including OtherConfig) including a set of configuration IDs corresponding to a set of configurations (e.g., a set of inference configurations) for which applicability information is requested. That is, the first control signaling may include a request for the UE 115-b to include the set of configuration IDs in an applicability report. The first control signaling may also include one or more indicators that indicate whether a configuration is allowable for AI/ML inference or for applicability determination only and excluded from use for AI/ML inference until enabled for use for one or more inference procedures by additional control signaling (e.g., a configuration including a set of inference-related parameter sets). For instance, the one or more indicators may indicate that a configuration is excluded from use for AI/ML inference until the UE 115-a receives additional control signaling containing a reconfiguration or an indication to use the configuration for AI/ML inference. In some aspects, the UE 115-b may receive the first control signaling via an RRC Reconfiguration message that indicates one or more CSI configurations, one or more RRC configurations, one or more parameters, or any combination thereof.

In some implementations, the one or more indicators included in the first control signaling may be one or more flags (e.g., 1 bit indications) corresponding to respective configurations of the set of configurations. A value of a flag may indicate whether a corresponding configuration is a configuration for applicability determination only that is excluded from use for AI/ML inference (e.g., until enabled for use for the one or more inference procedures by additional control signaling) or a configuration that is available for use for AI/ML inference. For example, a flag with a value of 1 or True may indicate a configuration for applicability determination that is excluded from use for AI/ML inference, while a flag with a value of 0 or False may indicate a configuration that is available for use for AI/ML inference. The network entity 105-b may signal the one or more flags via one or more RRC messages (e.g., RRCReconfiguration), via one or more CSI configuration messages (e.g., included in an IE, for example CSI-ReportConfigApp), or any combination thereof.

Additionally, or alternatively, the one or more indicators included in the first control signaling may be a bitmap corresponding to the set of configurations. Entries of the bitmap may correspond to the set of configurations and indicate whether a corresponding configuration is available for inference or for applicability determination only and excluded from use for AI/ML inference (e.g., until enabled for use for the one or more inference procedures by additional control signaling). For example, a value of 1 may indicate that an entry corresponds to a configuration that is excluded from use for AI/ML inference and a value of 0 may indicate that an entry corresponds to a configuration that is available for use for AI/ML inference (e.g., or vice versa). The network entity 105-b may configure the bitmap via one or more RRC messages (e.g., RRCReconfiguration), via one or more CSI configuration messages (e.g., included in an IE, for example CSI-ReportConfigApp), or any combination thereof.

At 320, the UE 115-b may generate and transmit an applicability report for one or more CSI report configurations (e.g., identified in the first control signaling). The UE 115-b may generate and transmit the applicability report in accordance with the one or more indicators and based on whether the one or more configurations are applicable for one or more inference procedures at the UE 115-b. For example, the UE 115-b may determine an applicability for inference of each configuration of the one or more configurations and set an applicability corresponding to each configuration as applicable or nonapplicable accordingly. If a configuration is applicable and a corresponding indicator (e.g., of the one or more indicators included in the first control signaling) indicates that the configuration is for applicability determination only and excluded from use for AI/ML inference (e.g., excluded from use with the one or more inference procedures), the UE 115-b may refrain from activating the configuration. If a configuration is applicable and a corresponding indicator (e.g., of the one or more indicators included in the first control signaling) indicates that the configuration is a configuration for inference, the UE 115-b may use (e.g., or activate) the configuration for inference. For example, a configuration may be a CSI report configuration, and the UE 115-b may determine to activate (e.g., immediately) the CSI report configuration if a corresponding report type is periodic, or the UE 115-b may refrain from activating the CSI report configuration until receiving a network indication (e.g., via MAC-CE or DCI) if the corresponding report type is aperiodic or semipersistent. The UE 115-b may include applicability information (e.g., or inapplicability information) of the one or more configurations in the applicability report based on setting the applicability of the one or more configurations as applicable or nonapplicable.

At 325, the UE 115-b may, in some examples, activate one or more configurations associated with periodic CSI reporting for the one or more inference procedures. In some aspects, the UE 115-b may activate the one or more configurations based on determining to activate the one or more configurations at 320, for example based on the one or more configurations being applicable and indicated as available for AI/ML inference by the one or more indicators.

At 330, the UE 115-b may receive, and the network entity 105-b may output, second control signaling indicating at least one configuration (e.g., at least one inference configuration) to be used for the one or more inference procedures. In some aspects, the at least one configuration may be at least one configuration that was indicated as excluded from AI/ML inference via the one or more indicators and for which the UE 115-b provided applicability information in the applicability report at 320. For instance, the network entity 105-b may determine that a configuration is applicable at the UE 115-b based on the applicability report, and the network entity 105-b may accordingly indicate, in the second control signaling, for the UE 115-b to use the configuration for the one or more inference procedures. In some cases, the second control signaling may indicate that one or more configurations that the one or more indicators previously indicated as being available for AI/ML inference are now excluded from use for AI/ML inference.

In some implementations, the second control signaling may be an RRC reconfiguration message (e.g., RRCReconfiguration) that indicates one or more inference configurations (e.g., CSI-ReportConfig for inference) corresponding to the at least one configuration. The RRC reconfiguration message may include one or more CSI configurations, one or more RRC configurations, one or more parameters, or any combination thereof. For instance, the second control signaling may include inference configurations for configuration IDs that are indicated as applicable in the applicability report and that are indicated as being excluded from use for AI/ML inference by the one or more indicators of the first control signaling. For example, the network entity 105-b may configure the UE 115-b with inference configurations for applicable configuration IDs for which the first control signaling previously configured the UE 115-b with a configuration including one or more inference-related parameter sets (e.g., instead of an inference configuration). In some cases, the second control signaling may include a mapping between the one or more inference configurations and the at least one configuration (e.g., or a corresponding configuration ID). In some examples, the network entity 105-b may output an indication to release, stop evaluating, or both, configurations (e.g., of the set of configurations identified in the first control signaling) that are indicated as being excluded from use for AI/ML inference via the one or more indicators.

Additionally, or alternatively, the second control signaling may include one or more additional indicators (e.g., flags, bitmaps). The one or more additional indicators may include at least one indicator that is different from an indicator of the one or more indicators of the first control signaling and that indicates the at least one configuration to be used for the one or more inference procedures. In some aspects, the one or more additional indicators may overwrite the one or more indicators of the first control signaling. For instance, the at least one indicator may include at least one updated value corresponding to the at least one configuration, where the updated value indicates that the configuration is available for use for AI/ML inference (e.g., while a previous value corresponding to the configuration may have indicated that the configuration is for applicability determination only and excluded from use for AI/ML inference). In some cases, the one or more additional indicators may indicate that one or more configurations of the set of configurations (e.g., identified in the first control signaling) that the one or more indicators previously indicated as being available for use for AI/ML inference are now excluded from use for AI/ML inference. The network entity 105-b may output the one or more additional indicators via an RRC message, a MAC-CE, DCI, or any combination thereof.

At 335, the UE 115-b may, in some examples, activate one or more configurations associated with aperiodic or semipersistent CSI reporting. In some aspects, the UE 115-b may activate the one or more configurations based on the one or more indicators and the second control signaling. For example, the one or more configurations may be applicable and indicated as being for available for AI/ML inference by the one or more indicators of the first control signaling, and the UE 115-b may refrain from activating the one or more configurations based on a corresponding report type being aperiodic or semipersistent until receiving a network indication (e.g., a MAC-CE or DCI) to activate the one or more configurations.

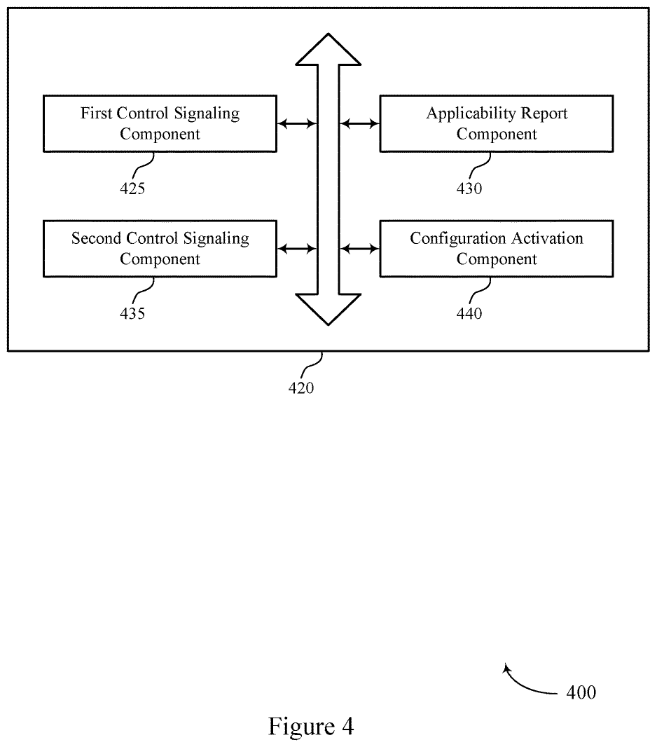

FIG. 4 shows an example of a processing system 420 that supports applicability reporting and inference configurations for inference procedures. A processing system 420 may be an example of a processing system 140 (such as of a UE 115) and may include a first control signaling component 425, an applicability report component 430, a second control signaling component 435, a configuration activation component 440, or any combination thereof. A processing system 420, or various component thereof, may be an example of means for performing (such as a means for causing a UE 115 to perform) various techniques described herein.

The first control signaling component 425 may be configured to cause the UE 115 to receive first control signaling including a set of configuration IDs corresponding to a set of configurations (e.g., configurations including inference-related parameters sets, inference configurations, CSI report configurations), the first control signaling further including one or more indicators that indicate whether one or more respective inference configurations from the set of configurations are for an applicability report. The applicability report component 430 may be configured to cause the UE 115 to transmit the applicability report for one or more configurations of the set of configurations in accordance with the one or more indicators and based on whether the one or more configurations are applicable for one or more inference procedures, whether the one or more configurations are for inclusion in the applicability report, or both. The second control signaling component 435 may be configured to cause the UE 115 to receive, based on the applicability report, second control signaling indicating at least one configuration to be used for the one or more inference procedures, where the at least one configuration is from a subset of configurations for the applicability report.

In some examples, the set of configurations includes one or more inference configurations, one or more CSI report configurations, one or more configurations including one or more inference-related parameter sets, or a combination thereof.

In some examples, the first control signaling is received via a RRC reconfiguration message that indicates one or more RRC configurations for applicability reporting, or one or more parameters, or any combination thereof.

In some examples, to support receiving the second control signaling, the second control signaling component 435 may be configured to cause the UE 115 to receive a RRC reconfiguration message indicating one or more inference configurations corresponding to the at least one configuration indicated for the applicability report via the one or more indicators.

In some examples, the RRC reconfiguration message indicates a mapping between the one or more inference configurations and the at least one configuration indicated for the applicability report via the one or more indicators.

In some examples, the second control signaling component 435 may be configured to cause the UE 115 to receive an indication to release or stop evaluating, or both, one or more respective configurations of the set of configurations that are indicated via the one or more indicators.

In some examples, the second control signaling component 435 may be configured to cause the UE 115 to receive, via the second control signaling, one or more additional indicators including at least one indicator that is different from an indicator of the one or more indicators received via the first control signaling, where the at least one indicator indicates the at least one configuration to be used for the one or more inference procedures.

In some examples, the second control signaling includes an RRC message, a MAC-CE, DCI, or any combination thereof.

In some examples, the one or more indicators may indicate whether the one or more respective inference configurations from the set of configurations are for the applicability report and excluded from use with the one or more inference procedures until additional control signaling enables the one or more respective inference configurations for use with the one or more inference procedures. In some examples, the at least one configuration indicated via the second control signaling may be from a subset of configurations for the applicability report and excluded from use with the one or more inference procedures.

In some examples, the second control signaling component 435 may be configured to cause the UE 115 to receive one or more additional indicators via the second control signaling, the one or more additional indicators including at least one indicator that updates an indicator of the one or more indicators received via the first control signaling. In some examples, the at least one indicator may signal that a first configuration is available for use with the one or more inference procedures, where the first configuration was previously signaled by the one or more indicators as being for the applicability report and excluded from use with the one or more inference procedures. In some examples, the at least one indicator may signal that a second configuration is for the applicability report and is excluded from use with the one or more inference procedures, where the second configuration was previously signaled by the one or more indicators as being available for the one or more inference procedures.

In some examples, a first configuration of the one or more respective inference configurations is associated with periodic CSI reporting, and the configuration activation component 440 may be configured to cause the UE 115 to activate the first configuration for the one or more inference procedures based on an applicability of the first configuration and based on the first configuration being available for use for the one or more inference procedures.

In some examples, a second configuration of the one or more respective inference configurations is associated with aperiodic or semipersistent CSI reporting, and the configuration activation component 440 may be configured to cause the UE 115 to activate the second configuration based on the second control signaling and the one or more indicators, and further based on the second configuration being available for use for the one or more inference procedures.

In some examples, the one or more indicators include one or more respective flags that each correspond to a configuration of the set of configurations. In some examples, a value of the one or more respective flags indicates whether the configuration is for the applicability report.

In some examples, the one or more respective flags are signaled via one or more RRC messages, via one or more CSI configuration messages, or any combination thereof.

In some examples, the one or more indicators include a bitmap indicating whether the one or more respective inference configurations are for the applicability report and excluded from use with the one or more inference procedures or whether the one or more respective inference configurations are for the applicability report and available for use with the one or more inference procedures, or any combination thereof.

In some examples, the configuration activation component 440 may be configured to cause the UE 115 to activate at least one inference configuration of the one or more respective inference configurations that are for the applicability report and available for use with the one or more inference procedures in accordance with a corresponding value of the bitmap.

In some examples, the bitmap is configured via one or more RRC messages, via one or more CSI configuration messages, or any combination thereof.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

In some cases, the first control signaling component 425, the applicability report component 430, the second control signaling component 435, and the configuration activation component 440 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of, the first control signaling component 425, the applicability report component 430, the second control signaling component 435, and the configuration activation component 440 discussed herein.”

By including or configuring a processing system 420 for operation in a processing system 420 as described herein, the processing system 420 may support techniques for reduced processing, reduced power consumption, and more efficient utilization of communication resources.

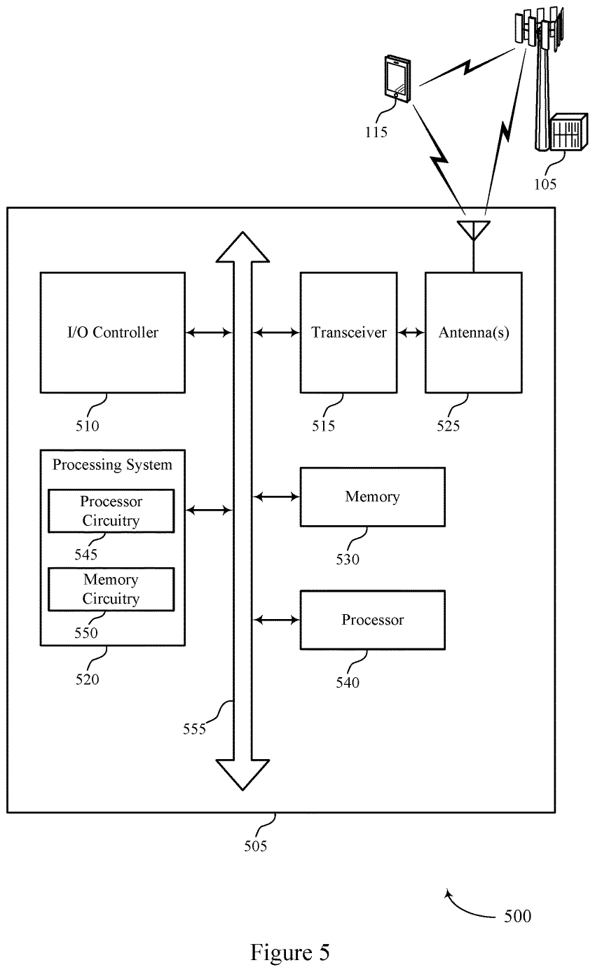

FIG. 5 shows an example of a system 500 including a device 505 that supports applicability reporting and inference configurations for inference procedures. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support applicability reporting and inference configurations for inference procedures. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved user experience related to reduced processing, reduced power consumption, more efficient utilization of communication resources, and longer battery life.

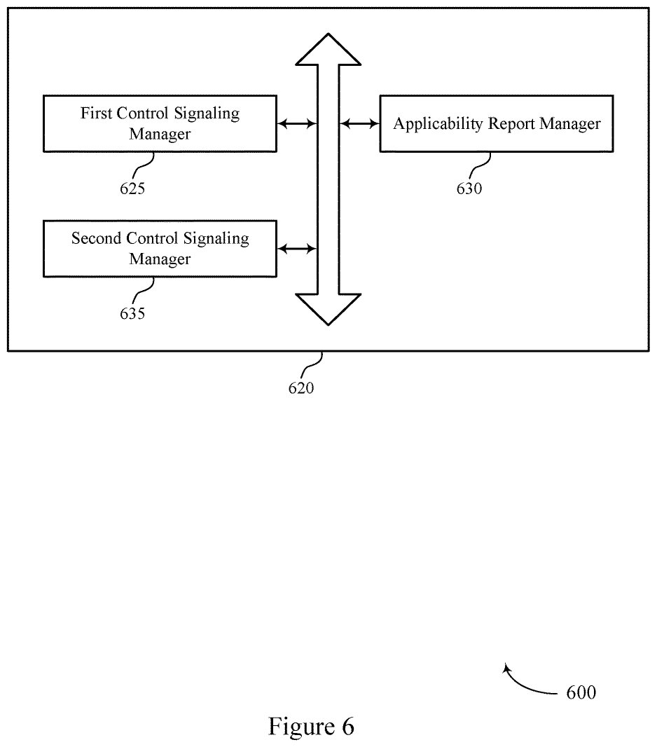

FIG. 6 shows an example of a processing system 620 that supports applicability reporting and inference configurations for inference procedures. A processing system 620 may be an example of a processing system 145 (such as network entity 105) and may include a first control signaling manager 625, an applicability report manager 630, a second control signaling manager 635, or any combination thereof. A processing system 620, or various component thereof, may be an example of means for performing (such as a means for causing a network entity 105 to perform) various techniques described herein.

The first control signaling manager 625 may be configured to cause the network entity 105 to output first control signaling including a set of configuration IDs corresponding to a set of configurations (e.g., configurations including inference-related parameters sets, inference configurations, CSI report configurations), the first control signaling further including one or more indicators that indicate whether one or more respective inference configurations from the set of configurations are for an applicability report. The applicability report manager 630 may be configured to cause the network entity 105 to obtain the applicability report for one or more configurations of the set of configurations in accordance with the one or more indicators and based on whether the one or more configurations are applicable for one or more inference procedures, whether the one or more configurations are for inclusion in the applicability report, or both. The second control signaling manager 635 may be configured to cause the network entity 105 to output, based on the applicability report, second control signaling indicating at least one configuration to be used for the one or more inference procedures, where the at least one configuration is from a subset of configurations for the applicability report.

In some examples, the set of configurations includes one or more inference configurations, one or more CSI report configurations, one or more configurations including one or more inference-related parameter sets, or a combination thereof.

In some examples, the first control signaling is received via a RRC reconfiguration message that indicates one or more RRC configurations for applicability reporting, or one or more parameters, or any combination thereof.

In some examples, to support outputting the second control signaling, the second control signaling manager 635 may be configured to cause the network entity 105 to output a RRC reconfiguration message indicating one or more inference configurations corresponding to the at least one configuration indicated for the applicability report via the one or more indicators.

In some examples, the RRC reconfiguration message indicates a mapping between the one or more inference configurations and the at least one configuration indicated for the applicability report via the one or more indicators.

In some examples, the second control signaling manager 635 may be configured to cause the network entity 105 to output an indication to release or stop evaluating, or both, one or more respective configurations of the set of configurations that are indicated via the one or more indicators.

In some examples, the second control signaling manager 635 may be configured to cause the network entity 105 to output, via the second control signaling, one or more additional indicators including at least one indicator that is different from an indicator of the one or more indicators received via the first control signaling, where the at least one indicator indicates the at least one configuration to be used for the one or more inference procedures.

In some examples, the second control signaling includes an RRC message, a MAC-CE, DCI, or any combination thereof.

In some examples, the one or more indicators may indicate whether the one or more respective inference configurations from the set of configurations are for the applicability report and excluded from use with the one or more inference procedures until additional control signaling enables the one or more respective inference configurations for use with the one or more inference procedures. In some examples, the at least one configuration indicated via the second control signaling is from a subset of configurations for the applicability report and excluded from use with the one or more inference procedures.

In some examples, the second control signaling manager 635 may be configured to cause the network entity 105 to output one or more additional indicators via the second control signaling, the one or more additional indicators including at least one indicator that updates an indicator of the one or more indicators received via the first control signaling. In some examples, the at least one indicator may signal that a first configuration is available for use with the one or more inference procedures, where the first configuration was previously signaled by the one or more indicators as being for the applicability report and excluded from use with the one or more inference procedures. In some examples, the at least one indicator may signal that a second configuration is for the applicability report and is excluded from use with the one or more inference procedures, where the second configuration was previously signaled by the one or more indicators as being available for the one or more inference procedures.

In some examples, the one or more indicators include one or more respective flags that each correspond to a configuration of the set of configurations. In some examples, a value of the one or more respective flags indicates whether the configuration is for the applicability report.

In some examples, the one or more indicators include a bitmap indicating whether the one or more respective inference configurations are for the applicability report and excluded from use with the one or more inference procedures or whether the one or more respective inference configurations are for the applicability report and available for use with the one or more inference procedures, or any combination thereof.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

In some cases, the first control signaling manager 625, the applicability report manager 630, and the second control signaling manager 635 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the first control signaling manager 625, the applicability report manager 630, and the second control signaling manager 635 discussed herein.”

By including or configuring a processing system 620 for operation in a processing system 620 as described herein, the processing system 620 may support techniques for reduced processing, reduced power consumption, and more efficient utilization of communication resources.

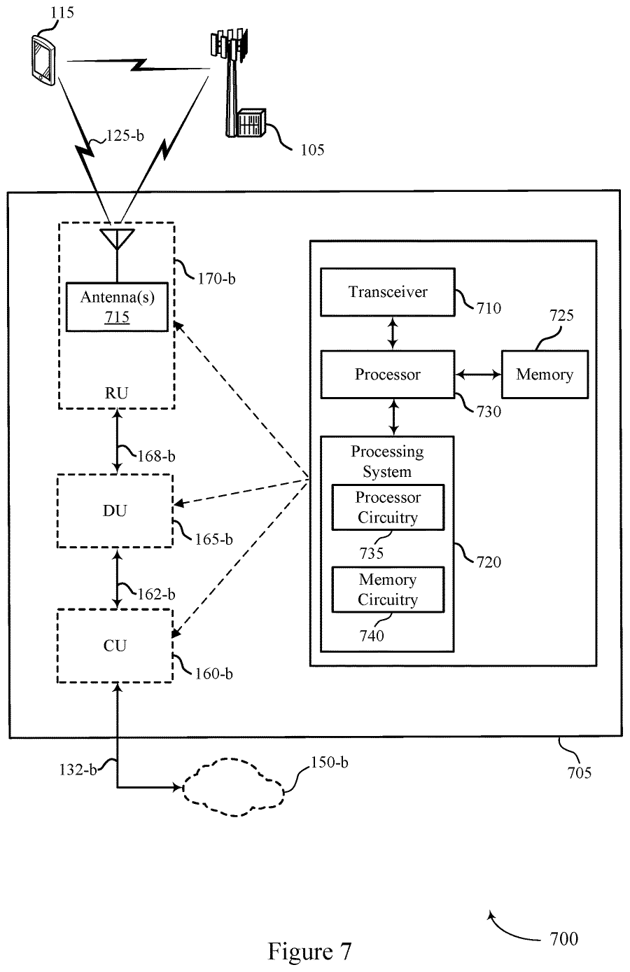

FIG. 7 shows an example of a system 700 including a device 705 that supports applicability reporting and inference configurations for inference procedures. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 600. For example, the processing system 720 may include processor circuitry 735 and memory circuitry 740 that stores code, and the processing system 720 may be configured to cause the device 705 to perform operations that support applicability reporting and inference configurations for inference procedures. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques reduced latency, improved user experience related to reduced processing, reduced power consumption, and, longer battery life.

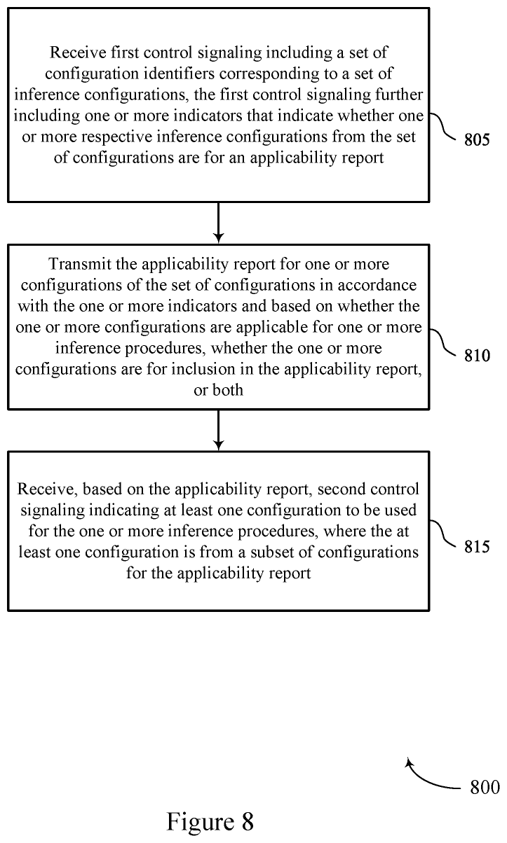

FIG. 8 shows an example of a method 800 that supports applicability reporting and inference configurations for inference procedures. Operations of the method 800 may be performed by a UE or its components (such as using a processing system configured to cause the UE 115 to perform one or more of the operations) as described herein.

At 805, the method may include receiving first control signaling including a set of configuration IDs corresponding to a set of configurations, the first control signaling further including one or more indicators that indicate whether one or more respective inference configurations from the set of configurations are for an applicability report. In some examples, aspects of the operations of 805 may be performed by a first control signaling component 425.

At 810, the method may include transmitting the applicability report for one or more configurations of the set of configurations in accordance with the one or more indicators and based on whether the one or more configurations are applicable for one or more inference procedures, whether the one or more configurations are for inclusion in the applicability report, or both. In some examples, aspects of the operations of 810 may be performed by an applicability report component 430.

At 815, the method may include receiving, based on the applicability report, second control signaling indicating at least one configuration to be used for the one or more inference procedures, where the at least one configuration is from a subset of configurations for the applicability report. In some examples, aspects of the operations of 815 may be performed by a second control signaling component 435.

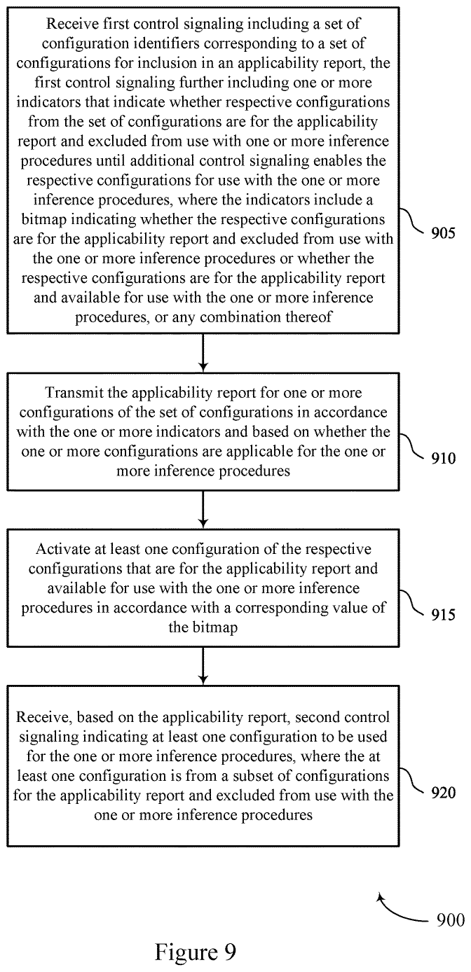

FIG. 9 shows an example of a method 900 that supports applicability reporting and inference configurations for inference procedures. Operations of the method 900 may be performed by a UE or its components (such as using a processing system configured to cause the UE 115 to perform one or more of the operations) as described herein.

At 905, the method may include receiving first control signaling including a set of configuration IDs corresponding to a set of configurations for inclusion in an applicability report, the first control signaling further including one or more indicators that indicate whether respective configurations from the set of configurations are for the applicability report and excluded from use with one or more inference procedures until additional control signaling enables the respective configurations for use with the one or more inference procedures, where the indicators include a bitmap indicating whether the respective configurations are for the applicability report and excluded from use with the one or more inference procedures or whether the respective configurations are for the applicability report and available for use with the one or more inference procedures, or any combination thereof. In some examples, aspects of the operations of 905 may be performed by a first control signaling component 425.

At 910, the method may include transmitting the applicability report for one or more configurations of the set of configurations in accordance with the one or more indicators and based on whether the one or more configurations are applicable for the one or more inference procedures. In some examples, aspects of the operations of 910 may be performed by an applicability report component 430.

At 915, the method may include activating at least one configuration of the respective configurations that are for the applicability report and available for use with the one or more inference procedures in accordance with a corresponding value of the bitmap. In some examples, aspects of the operations of 915 may be performed by a configuration activation component 440.

At 920, the method may include receiving, based on the applicability report, second control signaling indicating at least one configuration to be used for the one or more inference procedures, where the at least one configuration is from a subset of configurations for the applicability report and excluded from use with the one or more inference procedures. In some examples, aspects of the operations of 920 may be performed by a second control signaling component 435.

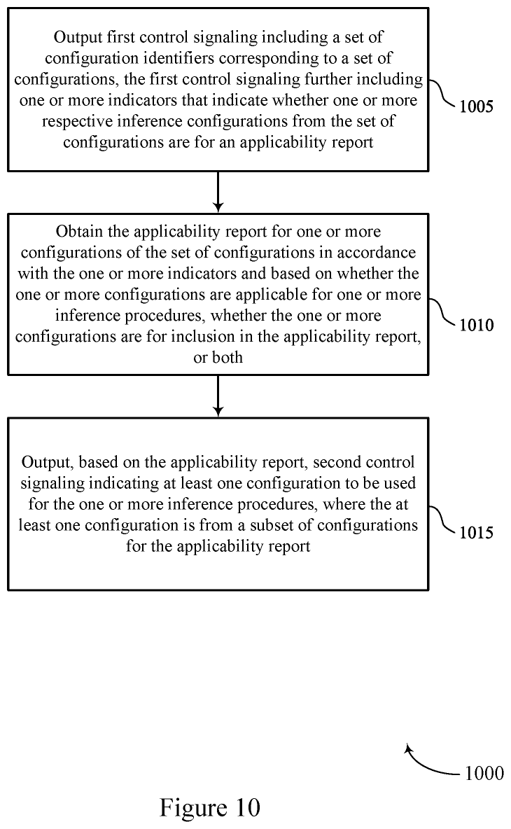

FIG. 10 shows an example of a method 1000 that supports applicability reporting and inference configurations for inference procedures. Operations of the method 1000 may be performed by a network entity 105 or its components (such as using a processing system configured to cause the network entity to perform one or more operations) as described herein.

At 1005, the method may include outputting first control signaling including a set of configuration IDs corresponding to a set of configurations, the first control signaling further including one or more indicators that indicate whether one or more respective inference configurations from the set of configurations are for an applicability report. In some examples, aspects of the operations of 1005 may be performed by a first control signaling manager 625.

At 1010, the method may include obtaining the applicability report for one or more configurations of the set of configurations in accordance with the one or more indicators and based on whether the one or more configurations are applicable for one or more inference procedures, whether the one or more configurations are for inclusion in the applicability report, or both. In some examples, aspects of the operations of 1010 may be performed by an applicability report manager 630.

At 1015, the method may include outputting, based on the applicability report, second control signaling indicating at least one configuration to be used for the one or more inference procedures, where the at least one configuration is from a subset of configurations for the applicability report. In some examples, aspects of the operations of 1015 may be performed by a second control signaling manager 635.

Implementation examples are described in the following numbered clauses:

Aspect 1: A method for wireless communication by a UE, comprising: receiving first control signaling comprising a set of configuration IDs corresponding to a set of configurations, the first control signaling further comprising one or more indicators that indicate whether one or more respective inference configurations from the set of configurations are for an applicability report; transmitting the applicability report for one or more configurations of the set of configurations in accordance with the one or more indicators and based at least in part on whether the one or more configurations are applicable for one or more inference procedures, whether the one or more configurations are for inclusion in the applicability report, or both; and receiving, based at least in part on the applicability report, second control signaling indicating at least one configuration to be used for the one or more inference procedures, wherein the at least one configuration is from a subset of configurations for the applicability report.

Aspect 2: The method of aspect 1, wherein the first control signaling is received via a RRC reconfiguration message that indicates one or more RRC configurations for applicability reporting, or one or more parameters, or any combination thereof.

Aspect 3: The method of any of aspects 1 through 2, wherein receiving the second control signaling comprises: receiving a RRC reconfiguration message indicating one or more inference configurations corresponding to the at least one configuration indicated for the applicability report via the one or more indicators.

Aspect 4: The method of aspect 3, wherein the RRC reconfiguration message indicates a mapping between the one or more inference configurations and the at least one configuration indicated for the applicability report via the one or more indicators.

Aspect 5: The method of any of aspects 3 through 4, further comprising: receiving an indication to release or stop evaluating, or both, one or more respective configurations of the set of configurations that are indicated via the one or more indicators.

Aspect 6: The method of any of aspects 1 through 5, further comprising: receiving, via the second control signaling, one or more additional indicators comprising at least one indicator that is different from an indicator of the one or more indicators received via the first control signaling, wherein the at least one indicator indicates the at least one configuration to be used for the one or more inference procedures.

Aspect 7: The method of aspect 6, wherein the second control signaling comprises an RRC message, a MAC-CE, DCI, or any combination thereof.

Aspect 8: The method of any of aspects 1 through 7, wherein the one or more indicators indicate whether the one or more respective inference configurations from the set of configurations are for the applicability report and excluded from use with the one or more inference procedures until additional control signaling enables the one or more respective inference configurations for use with the one or more inference procedures, and wherein the at least one configuration indicated via the second control signaling is from a subset of configurations for the applicability report and excluded from use with the one or more inference procedures.

Aspect 9: The method of aspect 8, further comprising: receiving one or more additional indicators via the second control signaling, the one or more additional indicators comprising at least one indicator that updates an indicator of the one or more indicators received via the first control signaling, wherein: the at least one indicator signals that a first configuration is available for use with the one or more inference procedures, wherein the first configuration was previously signaled by the one or more indicators as being for the applicability report and excluded from use with the one or more inference procedures; or the at least one indicator signals that a second configuration is for the applicability report and is excluded from use with the one or more inference procedures, wherein the second configuration was previously signaled by the one or more indicators as being available for the one or more inference procedures.

Aspect 10: The method of any of aspects 1 through 9, wherein a first configuration of the one or more respective inference configurations is associated with periodic CSI reporting, the method further comprising: activating the first configuration for the one or more inference procedures based at least in part on an applicability of the first configuration and based at least in part on the first configuration being available for use for the one or more inference procedures.

Aspect 11: The method of any of aspects 1 through 10, wherein a second configuration of the one or more respective inference configurations is associated with aperiodic or semipersistent CSI reporting, the method further comprising: activating the second configuration based at least in part on the second control signaling and the one or more indicators, and further based at least in part on the second configuration being available for use for the one or more inference procedures.

Aspect 12: The method of any of aspects 1 through 11, wherein the one or more indicators comprise one or more respective flags that each correspond to a configuration of the set of configurations, a value of the one or more respective flags indicates whether the configuration is for the applicability report.

Aspect 13: The method of aspect 12, wherein the one or more respective flags are signaled via one or more RRC messages, via one or more CSI configuration messages, or any combination thereof.

Aspect 14: The method of any of aspects 1 through 13, wherein the one or more indicators comprise a bitmap indicating whether the one or more respective inference configurations are for the applicability report and excluded from use with the one or more inference procedures or whether the one or more respective inference configurations are for the applicability report and available for use with the one or more inference procedures, or any combination thereof.

Aspect 15: The method of aspect 14, further comprising: activating at least one inference configuration of the one or more respective inference configurations that are for the applicability report and available for use with the one or more inference procedures in accordance with a corresponding value of the bitmap.

Aspect 16: The method of any of aspects 14 through 15, wherein the bitmap is configured via one or more RRC messages, via one or more CSI configuration messages, or any combination thereof.

Aspect 17: The method of any of aspects 1 through 16, wherein the set of configurations comprise one or more inference configurations, one or more CSI report configurations, one or more configurations including one or more inference-related parameter sets, or a combination thereof

Aspect 18: A method for wireless communication by a network node, comprising: outputting first control signaling comprising a set of configuration IDs corresponding to a set of configurations, the first control signaling further comprising one or more indicators that indicate whether one or more respective inference configurations from the set of configurations are for an applicability report; obtaining the applicability report for one or more configurations of the set of configurations in accordance with the one or more indicators and based at least in part on whether the one or more configurations are applicable for one or more inference procedures, whether the one or more configurations are for inclusion in the applicability report, or both; and outputting, based at least in part on the applicability report, second control signaling indicating at least one configuration to be used for the one or more inference procedures, wherein the at least one configuration is from a subset of configurations for the applicability report.

Aspect 19: The method of aspect 18, wherein the first control signaling is received via a RRC reconfiguration message that indicates one or more RRC configurations for applicability reporting, or one or more parameters, or any combination thereof.

Aspect 20: The method of any of aspects 18 through 19, wherein outputting the second control signaling comprises: outputting a RRC reconfiguration message indicating one or more inference configurations corresponding to the at least one configuration indicated for the applicability report via the one or more indicators.

Aspect 21: The method of aspect 20, wherein the RRC reconfiguration message indicates a mapping between the one or more inference configurations and the at least one configuration indicated for the applicability report via the one or more indicators.

Aspect 22: The method of any of aspects 20 through 21, further comprising: outputting an indication to release or stop evaluating, or both, one or more respective configurations of the set of configurations that are indicated via the one or more indicators.

Aspect 23: The method of any of aspects 18 through 22, further comprising: outputting, via the second control signaling, one or more additional indicators comprising at least one indicator that is different from an indicator of the one or more indicators received via the first control signaling, wherein the at least one indicator indicates the at least one configuration to be used for the one or more inference procedures.

Aspect 24: The method of aspect 23, wherein the second control signaling comprises an RRC message, a MAC-CE, DCI, or any combination thereof.

Aspect 25: The method of any of aspects 18 through 24, wherein the one or more indicators indicate whether the one or more respective inference configurations from the set of configurations are for the applicability report and excluded from use with the one or more inference procedures until additional control signaling enables the one or more respective inference configurations for use with the one or more inference procedures, and wherein the at least one configuration indicated via the second control signaling is from a subset of configurations for the applicability report and excluded from use with the one or more inference procedures.

Aspect 26: The method of aspect 25, further comprising: outputting one or more additional indicators via the second control signaling, the one or more additional indicators comprising at least one indicator that updates an indicator of the one or more indicators received via the first control signaling, wherein: the at least one indicator signals that a first configuration is available for use with the one or more inference procedures, wherein the first configuration was previously signaled by the one or more indicators as being for the applicability report and excluded from use with the one or more inference procedures; or the at least one indicator signals that a second configuration is for the applicability report and is excluded from use with the one or more inference procedures, wherein the second configuration was previously signaled by the one or more indicators as being available for the one or more inference procedures.

Aspect 27: The method of any of aspects 18 through 26, wherein the one or more indicators comprise one or more respective flags that each correspond to a configuration of the set of configurations, a value of the one or more respective flags indicates whether the configuration is for the applicability report.

Aspect 28: The method of any of aspects 18 through 27, wherein the one or more indicators comprise a bitmap indicating whether the one or more respective inference configurations are for the applicability report and excluded from use with the one or more inference procedures or whether the one or more respective inference configurations are for the applicability report and available for use with the one or more inference procedures, or any combination thereof.

Aspect 29: The method of any of aspects 18 through 28, wherein the set of configurations comprise one or more inference configurations, one or more channel state information report configurations, one or more configurations including one or more inference-related parameter sets, or a combination thereof

Aspect 30: A UE for wireless communication, comprising a processing system that includes processor circuitry and memory circuitry that stores code, the processing system configured to cause the UE to perform a method of any of aspects 1 through 17.

Aspect 31: A UE for wireless communication, comprising at least one means for performing a method of any of aspects 1 through 17.

Aspect 32: A non-transitory computer-readable medium storing code for wireless communication, the code comprising instructions executable by one or more processors to perform a method of any of aspects 1 through 17.

Aspect 33: A network node for wireless communication, comprising a processing system that includes processor circuitry and memory circuitry that stores code, the processing system configured to cause the network node to perform a method of any of aspects 18 through 29.

Aspect 34: A network node for wireless communication, comprising at least one means for performing a method of any of aspects 18 through 29.

Aspect 35: A non-transitory computer-readable medium storing code for wireless communication, the code comprising instructions executable by one or more processors to perform a method of any of aspects 18 through 29.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling comprising a set of configuration identifiers corresponding to a set of configurations, the first control signaling further comprising one or more indicators that indicate whether one or more respective inference configurations from the set of configurations are for an applicability report;
transmit the applicability report for one or more configurations of the set of configurations in accordance with the one or more indicators and based at least in part on whether the one or more configurations are applicable for one or more inference procedures, whether the one or more configurations are for inclusion in the applicability report, or both; and
receive, based at least in part on the applicability report, second control signaling indicating at least one configuration to be used for the one or more inference procedures, wherein the at least one configuration is from a subset of configurations for the applicability report.

2. The UE of claim 1, wherein the set of configurations comprise one or more inference configurations, one or more channel state information report configurations, one or more configurations including one or more inference-related parameter sets, or a combination thereof.

3. The UE of claim 1, wherein the first control signaling is received via a radio resource control reconfiguration message that indicates one or more radio resource control configurations for applicability reporting, or one or more parameters, or any combination thereof.

4. The UE of claim 1, wherein, to receive the second control signaling, the one or more processors are individually or collectively operable to execute the code to cause the UE to:
receive a radio resource control reconfiguration message indicating one or more inference configurations corresponding to the at least one configuration indicated for the applicability report via the one or more indicators.

5. The UE of claim 4, wherein the radio resource control reconfiguration message indicates a mapping between the one or more inference configurations and the at least one configuration indicated for the applicability report via the one or more indicators.

6. The UE of claim 4, wherein the one or more processors are individually or collectively further operable to execute the code to cause the UE to:
receive an indication to release or stop evaluating, or both, one or more respective configurations of the set of configurations that are indicated via the one or more indicators.

7. The UE of claim 1, wherein the one or more processors are individually or collectively further operable to execute the code to cause the UE to:
receive, via the second control signaling, one or more additional indicators comprising at least one indicator that is different from an indicator of the one or more indicators received via the first control signaling, wherein the at least one indicator indicates the at least one configuration to be used for the one or more inference procedures.

8. The UE of claim 1, wherein the one or more indicators indicate whether the one or more respective inference configurations from the set of configurations are for the applicability report and excluded from use with the one or more inference procedures until additional control signaling enables the one or more respective inference configurations for use with the one or more inference procedures, and wherein the at least one configuration indicated via the second control signaling is from a subset of configurations for the applicability report and excluded from use with the one or more inference procedures.

9. The UE of claim 8, wherein the one or more processors are individually or collectively further operable to execute the code to cause the UE to:
receive one or more additional indicators via the second control signaling, the one or more additional indicators comprising at least one indicator that updates an indicator of the one or more indicators received via the first control signaling, wherein:
the at least one indicator signals that a first configuration is available for use with the one or more inference procedures, wherein the first configuration was previously signaled by the one or more indicators as being for the applicability report and excluded from use with the one or more inference procedures; or
the at least one indicator signals that a second configuration is for the applicability report and is excluded from use with the one or more inference procedures, wherein the second configuration was previously signaled by the one or more indicators as being available for the one or more inference procedures.

10. The UE of claim 1, wherein a first inference configuration of the one or more respective inference configurations is associated with periodic channel state information reporting, and the one or more processors are individually or collectively further operable to execute the code to cause the UE to:
activate the first inference configuration for the one or more inference procedures based at least in part on an applicability of the first inference configuration and based at least in part on the first inference configuration being available for use for the one or more inference procedures.

11. The UE of claim 1, wherein a second inference configuration of the one or more respective inference configurations is associated with aperiodic or semipersistent channel state information reporting, and the one or more processors are individually or collectively further operable to execute the code to cause the UE to:
activate the second inference configuration based at least in part on the second control signaling and the one or more indicators, and further based at least in part on the second inference configuration being available for use for the one or more inference procedures.

12. The UE of claim 1, wherein the one or more indicators comprise one or more respective flags that each correspond to an inference configuration of the set of configurations, wherein a value of the one or more respective flags indicates whether the inference configuration is for the applicability report.

13. The UE of claim 12, wherein the one or more respective flags are signaled via one or more radio resource control messages, via one or more channel state information configuration messages, or any combination thereof.

14. The UE of claim 1, wherein the one or more indicators comprise a bitmap indicating whether the one or more respective inference configurations are for the applicability report and excluded from use with the one or more inference procedures or whether the one or more respective inference configurations are for the applicability report and available for use with the one or more inference procedures, or any combination thereof.

15. The UE of claim 14, wherein the one or more processors are individually or collectively further operable to execute the code to cause the UE to:
activate a first inference configuration of the one or more respective inference configurations that are for the applicability report and available for use with the one or more inference procedures in accordance with a corresponding value of the bitmap.

16. The UE of claim 14, wherein the bitmap is configured via one or more radio resource control messages, via one or more channel state information configuration messages, or any combination thereof.

17. A network node, comprising:
one or more memories storing processor-executable code; and
one or more processors coupled with the one or more memories and individually or collectively operable to execute the code to cause the network node to:
output first control signaling comprising a set of configuration identifiers corresponding to a set of configurations, the first control signaling further comprising one or more indicators that indicate whether one or more respective inference configurations from the set of configurations are for an applicability report;
obtain the applicability report for one or more configurations of the set of configurations in accordance with the one or more indicators and based at least in part on whether the one or more configurations are applicable for one or more inference procedures, whether the one or more configurations are for inclusion in the applicability report, or both; and
output, based at least in part on the applicability report, second control signaling indicating at least one configuration to be used for the one or more inference procedures, wherein the at least one configuration is from a subset of configurations for the applicability report.

18. The network node of claim 17, wherein the first control signaling is received via a radio resource control reconfiguration message that indicates one or more radio resource control configurations for applicability reporting, or one or more parameters, or any combination thereof.

19. The network node of claim 17, wherein the one or more processors are individually or collectively further operable to execute the code to cause the network node to:
output, via the second control signaling, one or more additional indicators comprising at least one indicator that is different from an indicator of the one or more indicators received via the first control signaling, wherein the at least one indicator indicates the at least one configuration to be used for the one or more inference procedures.

20. A method for wireless communication by a user equipment (UE), comprising:
receiving first control signaling comprising a set of configuration identifiers corresponding to a set of configurations, the first control signaling further comprising one or more indicators that indicate whether one or more respective inference configurations from the set of configurations are for an applicability report;
transmitting the applicability report for one or more configurations of the set of configurations in accordance with the one or more indicators and based at least in part on whether the one or more configurations are applicable for one or more inference procedures, whether the one or more configurations are for inclusion in the applicability report, or both; and
receiving, based at least in part on the applicability report, second control signaling indicating at least one configuration to be used for the one or more inference procedures, wherein the at least one configuration is from a subset of configurations for the applicability report.
